(19) United States
(12) Patent Application Publication
(10) Pub. No.: US 2024/0341231 A1
(43) Pub. Date: Oct. 17, 2024

(54) CROP RESIDUE MONITORING SYSTEM AND METHOD

(71) Applicant: Deere & Company, Moline, IL (US)

(72) Inventors: Nathan R. Vandike, Geneseo, IL (US); Benjamin Peschel, Contwig (DE); Kelli L. Martin, Morton, IL (US); Lucian V. Banitz, New Richmond, WI (US)

(21) Appl. No.: 18/299,946

(22) Filed: Apr. 13, 2023

(51) Int. Cl. A01D 41/127; A01D 41/12; G01D 21/02; G01S 13/86

(52) U.S. Cl. CPC A01D 41/127; A01D 41/1243; G01D 21/02; G01S 13/862; G01S 13/865; G01S 13/867

(57) ABSTRACT

A monitoring system for an agricultural machine includes one or more sensors mounted to one or more locations on the agricultural machine and a controller. The controller is configured to: receive a plurality of sensor outputs; determine one or more features of quality for one or more sensor outputs; determine one or more features of merit for the one or more sensor outputs, the one or more features of merit corresponding to operation of the agricultural machine and having one or more confidence scores associated therewith; select a sensor output from the plurality of sensor outputs as a selected sensor output according to the one or more features of quality for the one or more sensor outputs of the plurality of sensor outputs; and control the operation of the agricultural machine according to the one or more features of merit for the selected sensor output.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates generally to agricultural combines. In particular, it relates to systems and methods for monitoring discharge from agricultural equipment, such as crop residue from an agricultural harvester.

### BACKGROUND OF THE DISCLOSURE

Crop residue is a byproduct of a crop harvesting operation. Crop residue may include straw, chaff, or other unwanted portions of a crop plant following a threshing process, a separation process, or both, by a harvester. Crop residue may additionally include other biomass such as weeds, weed seeds, and the like. Such residue is often discharged from the harvester.

### SUMMARY OF THE DISCLOSURE

A monitoring system for an agricultural machine includes one or more sensors mounted to one or more locations on the agricultural machine; and a controller. The controller is configured to: receive a plurality of sensor outputs from the one or more sensors; determine one or more features of quality for one or more sensor outputs of the plurality of sensor outputs; determine one or more features of merit for the one or more sensor outputs of the plurality of sensor outputs, the one or more features of merit corresponding to operation of the agricultural machine and having one or more confidence scores associated therewith; select a sensor output from the plurality of sensor outputs as a selected sensor output according to the one or more features of quality for the one or more sensor outputs of the plurality of sensor outputs; and control the operation of the agricultural machine according to the one or more features of merit for the selected sensor output.

Regarding the monitoring system, the one or more features of quality for the one or more sensor outputs of the plurality of sensor outputs includes a fraction of the one or more sensor outputs of the plurality of sensor outputs obscured by an obscurant.

Regarding the monitoring system, the one or more features of quality for the one or more sensor outputs of the plurality of sensor outputs includes a characterization of lighting represented in the one or more sensor outputs of the plurality of sensor outputs.

Regarding the monitoring system, the one or more features of merit characterize a plume of crop residue released by the agricultural machine and represented in one or more sensor outputs of the plurality of sensor outputs; and the one or more features of merit include at least one of a width, a distribution, or a direction of the plume of crop residue.

Regarding the monitoring system, the controller is configured to control the operation of the agricultural machine according to the one or more features of merit by controlling at least one of a speed, a position or a direction of at least one of a spreader mechanism, a chopper, or a harvester head.

Regarding the monitoring system, the controller is configured to control operation of the agricultural machine according to the one or more features of merit by controlling a display device.

Regarding the monitoring system, the one or more features of merit correspond to operation of the agricultural machine and have one or more confidence scores associated therewith, and the controller is further configured to select the sensor output as the selected sensor output additionally based on the one or more confidence scores for the one or more sensor outputs of the plurality of sensor outputs.

Regarding the monitoring system, the one or more sensors include a plurality of sensors each having a priority associated therewith; and the controller is configured to select the sensor output from the plurality of sensor outputs as the selected sensor output according to two or more of the priorities of the plurality of sensors, the one or more features of quality, and the one or more confidence scores for the one or more sensor outputs of the plurality of sensor outputs.

Regarding the monitoring system, the one or more sensors comprise at least one of a light detection and ranging (LIDAR) sensor, a radio detection and ranging (RADAR) sensor, an ultrasonic sensor, an ultraviolet sensor, an infrared sensor, or a visible light camera.

Regarding the monitoring system, the one or more sensors includes two or more cameras, including at least one camera configured to detect rearward of the agricultural machine.

A method for monitoring an agricultural machine includes receiving, by a computing device, a plurality of sensor outputs from one or more sensors mounted to one or more locations on the agricultural machine; determining, by the computing device, one or more features of quality for one or more sensor outputs of the plurality of sensor outputs; determining, by the computing device, one or more features of merit for the one or more sensor outputs of the plurality of sensor outputs, the one or more features of merit corresponding to operation of the agricultural machine; selecting, by the computing device, a sensor output from the plurality of sensor outputs as a selected sensor output according to the one or more features of quality of the one or more sensor outputs of the plurality of sensor outputs; and controlling, by the computing device, the operation of the agricultural machine according to the one or more features of merit for the selected sensor output.

Regarding the method, the one or more features of quality for the one or more sensor outputs of the plurality of sensor outputs includes a fraction of the one or more sensor outputs obscured by an obscurant.

Regarding the method, the one or more features of quality for the one or more sensor outputs of the plurality of sensor outputs includes a characterization of lighting represented in the one or more sensor outputs.

Regarding the method, the one or more features of merit characterize a plume of crop residue released by the agricultural machine and represented in the one or more sensor outputs of the plurality of sensor outputs; and the one or more features of merit include at least one of a width, a distribution, and a direction of the plume of crop residue.

The method further includes controlling, by the computing device, the operation of the agricultural machine according to the one or more features of merit by controlling at least one of a speed, a position, or a direction of at least one of a spreader mechanism, a chopper, or a harvester head.

The method further includes controlling, by the computing device, the operation of the agricultural machine according to the one or more features of merit by controlling a display device.

8 Regarding the method, the one or more features of merit correspond to operation of the agricultural machine and have one or more confidence scores associated therewith. The method further includes selecting, by the computing device, the sensor output from the plurality of sensor outputs as the selected sensor output additionally according to the one or more confidence scores for the one or more sensor outputs of the plurality of sensor outputs.

Regarding the method, the one or more sensors include a plurality of sensors each having a priority associated therewith. The method further includes selecting the sensor output from the plurality of sensor outputs as the selected sensor output according to two or more of the priorities of the plurality of sensors, the one or more features of quality, and the one or more confidence scores for the one or more sensor outputs of the plurality of sensor outputs.

Regarding the method, the one or more sensors comprise at least one of a light detection and ranging (LIDAR) sensor, a radio detection and ranging (RADAR) sensor, an ultrasonic sensor, an ultraviolet sensor, an infrared sensor, and a visible light camera.

Regarding the method, the one or more sensors include two or more cameras, including at least one camera configured to detect rearward of a spreader mechanism of the agricultural machine.

### BRIEF DESCRIPTION OF THE DRAWINGS

FIG. 1 is a side view of an agricultural harvester for use with a residue spread monitoring system in accordance with the present disclosure;

FIG. 2 is a plan view of the agricultural harvester of FIG. 1;

FIG. 3 is a schematic diagram of the residue spread monitoring system of FIGS. 1-2 in accordance with an example embodiment;

FIG. 4 is a schematic diagram of components of an ECU implementing the residue spread monitoring system in accordance with an example embodiment;

FIG. 5 is a process flow diagram of a method for controlling the spread of crop residue in accordance with an example embodiment; and

FIGS. 6, 7, and 8 are example images that may be used to monitor the spread of crop residue in accordance with an example embodiment.

Like reference symbols in the various drawings indicate like elements.

### DETAILED DESCRIPTION

The following describes one or more example embodiments of the disclosed crop residue monitoring system and method, as shown in the accompanying figures of the drawings described briefly above. Various modifications to the example embodiments may be contemplated by one of skill in the art. Discussion herein may sometimes focus on the example application in an agricultural harvester, but the disclosed system and method are applicable to other types of work vehicles and/or other types of work environments.

As noted, there are a wide variety of different types of agricultural machines, forestry machines, and/or construction machines. As examples, some agricultural machines include harvesters, such as combine harvesters, sugar cane harvesters, cotton harvesters, self-propelled forage harvesters, and windrowers. Harvest operations may involve various types of systems and management mechanisms in order to improve overall performance and production.

Agricultural harvesters such as combines or windrowers, travel through fields of agricultural crop harvesting the crop. In one common arrangement, agricultural harvesting heads are positioned at the front of the agricultural harvester to engage the plant stalks, sever them, and carry the severed crop into the body of the agricultural harvester itself for further processing. Threshing, cleaning and separating mechanisms inside the agricultural harvester are provided to separate grain from material other than grain (e.g., to result in “crop residue”), such as straw. Once separated, the crop residue is carried to the rear of the combine, chopped, and spread over the ground behind the combine. A common issue when spreading crop residue behind the agricultural harvester is accurately monitoring the spread of the crop residue, particularly when there are strong prevailing winds. The crop residue is thrown to the rear and the sides of the vehicle, and the wind further impacts a spread pattern of the crop residue. Monitoring the spreading of the crop residue may also be a challenge in dusty environments and low light conditions.

Control systems are provided to monitor the spread of the crop residue behind the agricultural harvester and to control blades, vanes, shrouds, and/or other steering devices to ensure that the crop residue is properly distributed on the ground behind the agricultural harvester. These control systems include cameras or other sensors (herein “cameras”) disposed to sense the characteristics and location of the crop residue in the field behind the agricultural harvester.

The process of spreading the crop residue produces a lot of dust, however. This dust obscures the view of the cameras, and thus prevents the control system from accurately determining the spread of the crop residue on the ground. In addition, shadows cast by the agricultural harvester or other structures may also obscure a view of the crop residue on the ground. Generally, dust, shadows, low light conditions, or other impediments may present challenges with respect to accurately monitoring the crop residue.

According to the disclosure herein, a system (and method) for monitoring crop residue may be provided. As an example, the system may dynamically evaluate images from a plurality of cameras and select one or more of the images that will be used to characterize the spreading of crop residue by the agricultural harvester. The cameras may be of multiple types and may have multiple mounting locations. For example, the cameras may include visible light cameras or infrared cameras. The mounting locations of the cameras may include the harvester head, the roof or sides of the agricultural harvester, the rear of the agricultural harvester at various elevations and horizontal positions, or other locations.

The system evaluates images from the plurality of cameras to select an image that is used to assess the spreading of crop residue by the agricultural harvester and control operation of the agricultural harvester in order to adjust the spreading of crop residue. The images may be processed to identify “features of quality,” such as portions of the images corresponding to airborne dust or other obscurants, light quality, or other features. The images may be further processed to identify “features of merit,” e.g., qualities of the crop-residue represented in the images that correspond to operation of the agricultural harvester, such as spread width, residue location, spread edge, spread distribution, chop quality, or the like. A confidence value for the features of merit may also be calculated. The features of quality and the confidence values for the images may be evaluated to select an image to assess the spreading of crop residue by the agricultural harvester. The cameras may each have a priority associated therewith such that an image may be selected based on a combination of the camera priorities, features of quality, and the confidence values.

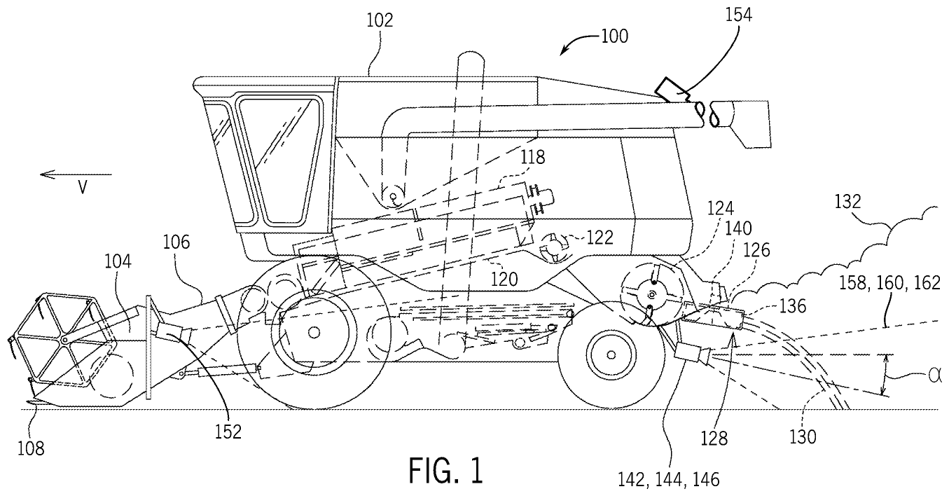

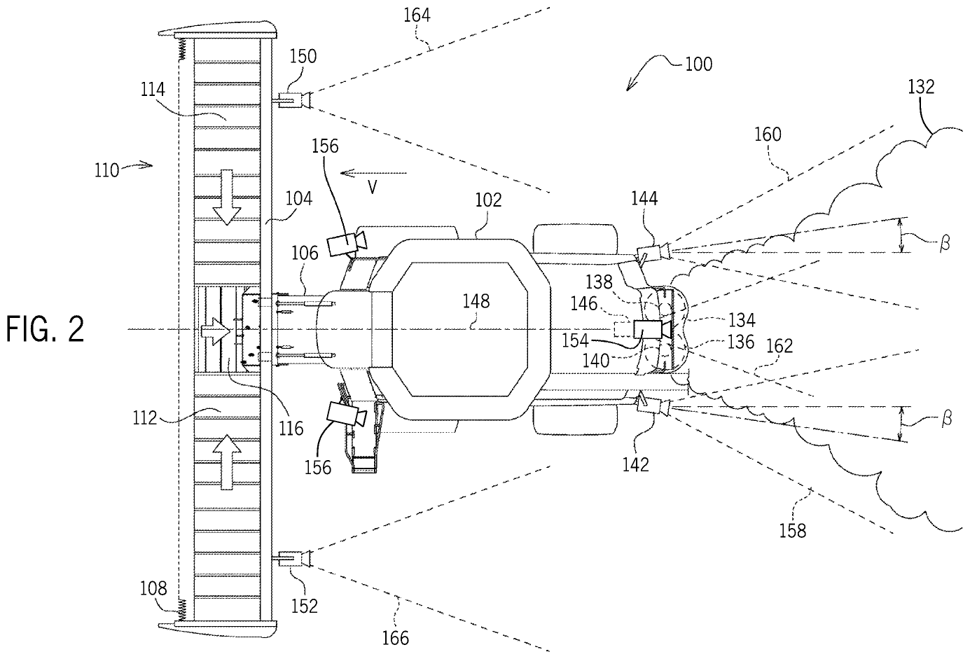

Referring to FIGS. 1 and 2, a work vehicle implementing the system and methods disclosed herein may be embodied as the illustrated agricultural harvester 100 or other type of work vehicle. The illustrated agricultural harvester 100 may include a self-propelled agricultural harvesting vehicle 102 and an agricultural harvesting head 104 supported on the front of the agricultural harvesting vehicle 102. The agricultural harvesting vehicle 102 includes a feederhouse 106 that is coupled to the forward end of the agricultural harvesting vehicle 102 and to which is coupled the agricultural harvesting head 104.

The agricultural harvesting head 104 includes a reciprocating knife 108 that is fixed to and extends across the front of the agricultural harvesting head 104. Behind the reciprocating knife 108 is a conveyor system 110, which comprises a left side conveyor 112, right side conveyor 114 and a center conveyor 116. The left side conveyor 112 has an endless belt upon which material cut by the reciprocating knife falls. This cut crop material is carried inwardly toward a central region of the agricultural harvesting head. The right side conveyor 114 has an endless belt upon which material cut by the reciprocating knife falls. This cut crop material is carried inwardly toward central region of the agricultural harvesting head 104. The center conveyor 116 is disposed between the left side conveyor 112 and the right side conveyor 114, receives crop from both, and carries the crop rearward into an opening at the forward end of the feederhouse 106. The feederhouse 106 includes an internal conveyor (not shown) that lifts the cut crop material up and carries it into the body of the agricultural harvesting vehicle 102. Once received in the body of the agricultural harvesting vehicle 102, the cut crop material is conveyed into a gap between an elongate rotor 118 and a concave grating 120. The cut crop material is threshed and separated between the elongate rotor 118 and the concave grating 120 as the rotor rotates against the stationary concave grating. The concave grating may be adjustable to adjust a clearance between the concave grating and the rotor.

Upon separation from the grain, the remaining material, known as “residue”, is carried rearward in the gap between the elongate rotor 118 and the concave grating 120 until the exiting adjacent to a beater 122. The crop residue is beaten by the beater 122 to separate any remaining kernels of grain from the crop residue. The crop residue then falls downward and rearward into a chopper 124. The chopper 124 comminutes the crop residue into smaller portions for easier distribution over the ground and easier digestion by microbes in the soil. The operation of the chopper 124 (e.g., speed of rotation, relative positions of one or more knives, etc.) may be adjustable in order to change the size of pieces in the crop residue discharged from the chopper 124 and/or the velocity at which the crop residue exits the chopper 124.

Comminuted crop residue is conveyed rearward by the chopper 124 into a spreader mechanism 126. The spreader mechanism 126 may be a powered or non-powered spreading device. It may include one or more motor-driven rotating discs with paddles or vanes, or it may include stationary paddles or vanes that steer the residue laterally, from side to side. In either case, whether driven or non-driven, the spreader mechanism 126 spreads the crop residue out into a broad fan like pattern behind the agricultural harvesting vehicle 102.

The spreader mechanism 126 may include two spinning discs 134, 136 driven by motors 138, 140. These spinning discs have downwardly extending vanes that engage the chopped residue and fling it outward and rearward to both sides of the agricultural harvesting vehicle 102.

29 Once released at the outlet of the spreader mechanism 126, the plume of residue 130 may settle to the ground behind the agricultural harvesting vehicle 102. The air mixed in with the residue produces a cloud of dust 132 that billows upward from the residue as the residue falls downward under the force of gravity onto the ground.

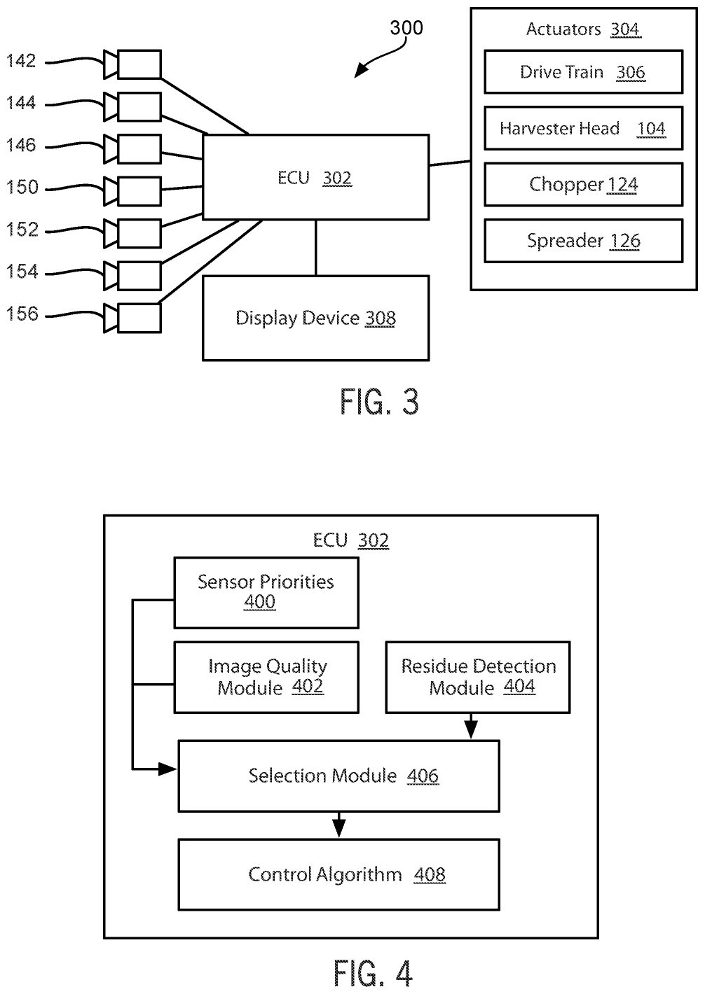

The agricultural harvester 100 may include a number of cameras 142, 144, 146, 150, 152, 154, 156 mounted at various locations. The cameras 142, 144, 146, 150, 152, 154, 156 may be of multiple types having a different imaging modality or multiple different imaging modalities. For example, the cameras may include visible light cameras or infrared cameras. Other imaging modalities may include light detection and ranging (LIDAR), radio detection and ranging (RADAR), ultrasonic imaging, ultraviolet imaging, or other imaging modality. In any event, the cameras 142, 144, 146, 150, 152, 154, 156 may produce digital or analog signals representing images of the plume of residue 130 within their fields of view. The cameras 142, 144, 146, 150, 152, 154, 156 are coupled to one or more computing devices (e.g., an ECU 302, such as depicted in FIG. 3 and described below) to receive images of the plume of residue 130.

Where sensors other than visible light cameras are used, the outputs of the sensors may be in the form of images, such as for infrared or ultraviolet cameras. For other sensors, such as LIDAR, RADAR, and ultrasonic sensors, the sensor output may be in the form of representation of objects detected in a three-dimensional space, such as a point cloud. Although processing of images is described below, it shall be understood that a three-dimensional representation may be processed in a like manner. In particular, reflections from dust or other obscurants may be detected in order to determine the features of quality of the three-dimensional representation. For many sensors, electromagnetic radiation is emitted by the sensor such that evaluation of lighting is not performed.

As shown in FIG. 2, cameras 142, 144 may be mounted at the rear of the agricultural harvesting vehicle 102 on either side of the chopper 124 and the spreader mechanism 126 and below the outlet of the chopper 124 and the spreader mechanism 126. A camera 146 may be disposed in a central region of the agricultural harvesting vehicle 102 in a location between cameras 142, 144. The camera 146 may also be disposed below the outlet of the chopper 124 and the spreader mechanism 126.

Generally, the cameras 142, 144, 146 may be pointed toward the rear of the harvesting vehicle 102 such that at least a portion of the plume of residue 130 underneath the cloud of dust 132 is in the field of view of the cameras 142, 144, 146. In this manner, the cameras can directly view the underside of the falling plume of residue itself, in the air, and unblocked by the cloud of dust 132.

In one example, the cameras 142, 144, 146 may point generally rearward in a horizontal plane, parallel to the ground, thereby imaging the plume of residue 130 in the air, and not against a backdrop of the ground. This positioning may avoid or mitigate the issue of distinguishing the crop residue from ground clutter in the imaging field.

More specifically, the cameras 142, 144, 146 may be disposed such that the central axis of each camera's field of view is at an angle alpha (α) with respect to horizontal, where the angle a is between plus 15 degrees and minus 15 degrees (“plus” being above horizontal and “minus” being below horizontal). The angle α may be between zero degrees (i.e., horizontal) and plus 5 degrees. For example, the angle α may be zero (i.e., horizontal). These values of the angle α are exemplary only and other angles, such as an angle between +/−45 degrees, may also be used.

The cameras 142, 144 may be disposed angled outward, such that the central axis of each camera's field of view is at an angle beta (β) with respect to a fore and aft plane 148 (in plan view) of between zero (i.e., directly rearward) degrees and plus 45 degrees, or some other angle. In some instances, angle β is between zero degrees and plus 30 degrees. In further instances, angle β is between zero degrees and plus 15 degrees. An angle β is positive (“plus”) if the camera is turned outward in a direction away from the side of the vehicle on which it is mounted. By directing the cameras outward (see FIG. 2), the overlap of the camera fields of view can be reduced and more of the plume of residue 130 can be included in the collective field of view of both cameras 142, 144.

The cameras 142, 144, 146 may be fixed in a position below the outlet of the chopper 124 and the spreader mechanism 126 so that the plume of residue 130 above the ground is falling into the field of view of the cameras 142, 144, 146. The cameras 142, 144, 146 may be disposed with respect to each other such that cameras 142 and 144 have mutually overlapping fields of view 158, 160 and that the field of view 162 of camera 146 overlaps the fields of view of both cameras 142, 144. In other embodiments, some or all of the cameras 142, 144, 146, 154, 156 have fields of view that do not overlap one another.

In one arrangement, the central camera 146 is additionally used. In another arrangement the cameras 142, 144 located on either side of (and below) the chopper 124 and the spreader mechanism 126 are used. In another arrangement, all three are used.

Additional cameras 150, 152, 154, 156 may be provided on the agricultural harvester 100. For example, a camera 150 may be provided on the right-hand side of the agricultural harvesting head 104, and a camera 152 may be provided on the left-hand side of the agricultural harvesting head 104. One or more additional cameras 154 may be mounted to the sides or roof of the agricultural harvesting vehicle 102 above the spreader mechanism 126; and one or more additional cameras 156 may be mounted to the mirrors of the agricultural harvesting vehicle 102 or elsewhere on or around the cab of the agricultural vehicle 102, on external platforms, or on another portion of the agricultural vehicle 102.

As shown, camera 150 has a field of view 164 and camera 152 has a field of view 166. The field of view 164 of camera 150 may extend outside of the field of view 160 of the camera 144 in the vicinity of the plume of residue 130. In this way, camera 150 overlaps and extends the field of view of camera 144. In a similar fashion, the field of view 164 of camera 150 extends outside of the field of view 160 of camera 144. Likewise, the field of view 166 of the camera 152 overlaps and extends the field of view 158 of the camera 142. The camera 154 may be positioned at an elevation and orientation such that the field of view of the camera 154 encompasses substantially all (e.g., at least 90 percent) of the combined fields of view of the cameras 142, 144, 146.

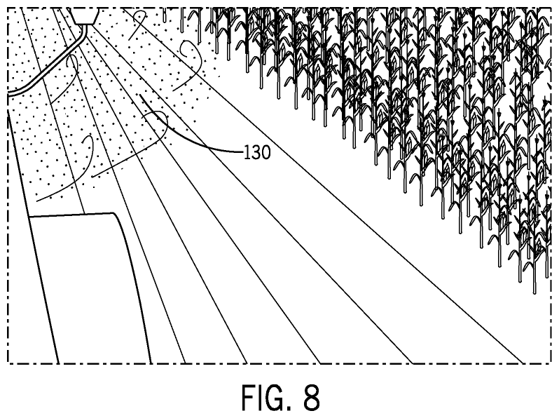

Briefly, reference is made to FIGS. 6-8, which depict examples images for the fields of view of cameras 150, 154, 156. For example, FIG. 6 illustrates an image that may be captured using the camera 154; FIG. 7 illustrates an image that may be captured using the camera 150; and FIG. 8 illustrates an image that may be captured using the one or more cameras 156. Additional information regarding these fields of view is provided below.

As such and returning to FIGS. 1 and 2, the overlapping fields of view of the cameras 142, 144, 146, 150, 152, 154, 156 permit the system to image substantially the entire width of the plume of residue 130 falling from the agricultural harvester 100 as well as the ground behind the agricultural harvester 100 over which the plume of residue 130 is scattered. As described below, one or more of the images may be evaluated by the crop residue monitoring system and method; and as part of this evaluation, the quality of each image may be evaluated (e.g., based on lighting or obscurants) as “features of quality” in order to influence how the images are prioritized and used.

As described below, the digital or analog signals from the cameras 142, 144, 146, 150, 152, 154, 156 may be evaluated in order to extract physical characteristics of the plume of residue 130 from the one or more of the images as described below. These characteristics may include characteristics of the distribution of the plume of residue, such as a location, spread edge, a width of the plume of residue 130 and a direction of the plume of residue 130 behind the agricultural harvester 100, e.g., how far to the right and/or how far to the left of the agricultural harvester 100. These characteristics may include characteristics of the crop residue itself. For example, these characteristics may include a numerical statistic such as average residue/straw length. These characteristics may include a categorization of the crop residue such as a type of crop residue, percent of different types of crop residue found in the image of the like. These characteristics may include a categorization of the crop residue in terms of processing of the crop residue such as under processed, over processed and the like, wherein the “processing” refers to the degree to which the crop residue has been changed or reduced in size by the harvester and/or otherwise manipulated (e.g., spreading, transporting, treating, etc.). Generally, some or all of these characteristics may be considered “features of merit” that quantify and/or qualify the plume of residue 130. The features of merit may be used to control the spreader mechanism 126 and other actuators in order to direct the plume of residue 130 across the ground in a more even distribution in one or both of the width and direction of the plume of residue 130.

Referring to FIG. 3, a system 300 for monitoring crop residue and controlling the processing of crop residue includes the ECU 302, which is coupled to or otherwise considered to include some or all of the cameras 142, 144, 146, 150, 152, 154, 156 and receives digital or analog signals from some or all of the cameras 142, 144, 146,150, 152, 154, 156 representing images. The system 300 may additionally be considered to include or otherwise cooperate with one or more actuators 304 (e.g., a drive train 306, agricultural harvesting head 104, chopper 124, and/or spreader mechanism 126) and/or one or more display devices 308.

Generally, the ECU 302 may be a controller that implements operation of the crop residue monitoring system 300, as well as other systems and components of the agricultural harvester 100, including any of the functions described herein. The ECU 302 may be configured as computing devices with associated processor devices and memory architectures. For example and as described below, the ECU 302 may implement functional modules or units with the processor based on programs or instructions stored in memory. In some examples, the consideration and implementation of aspects of the crop residue monitoring system 300 by the ECU 302 are continuous, e.g., constantly active. In other examples, the activation may be selective, e.g., enabled or disabled based on input from the operator or other considerations.

As noted, the ECU 302 is further coupled to one or more actuators 304 for controlling operation of the agricultural harvester 100 in response to analysis of the images by the ECU 302. For example, the actuators 304 may include the drive train 306 of the agricultural harvester 100. The drive train 306 may include a prime mover, such as an internal combustion engine (gasoline, diesel, natural gas, propane, etc.) or an electric motor. The drive train 306 may further include a transmission for transmitting torque between the prime mover and wheels or tracks of the agricultural harvester 100. The actuators 304 may include the agricultural harvesting head 104, e.g., actuators for driving the reciprocating knife 108, adjusting a height of the harvesting head 104, or controlling other aspects of the agricultural harvesting head 104. The actuators 304 may further include the chopper 124 and spreader mechanism 126. In some aspect, the display device 308 may also be considered an actuator for the agricultural harvester 100 in that the display device 308 may be commanded by the ECU 302 to manipulate display elements as part of the crop residue monitoring system 300.

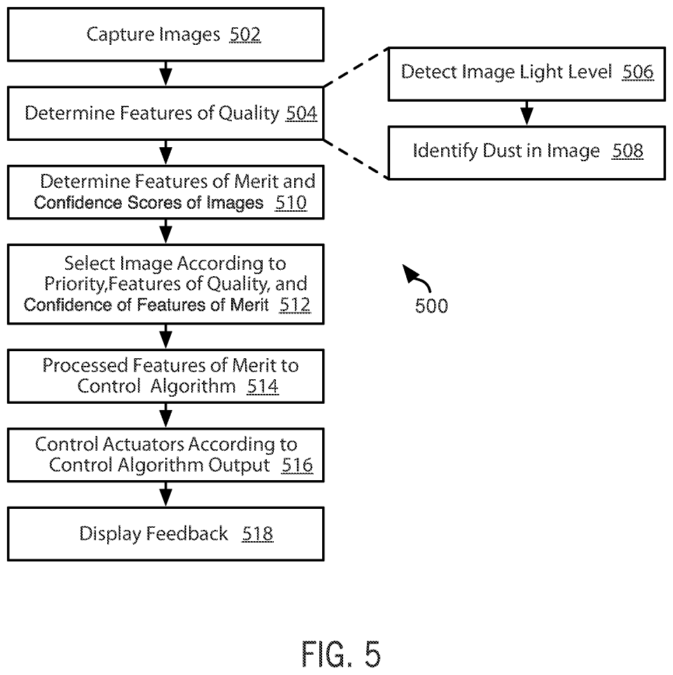

As also noted, the ECU 302 may further be coupled to the display device 308. The display device 308 may be located in a cab of the agricultural harvester 100 or be remote from the agricultural harvester 100, such as in the case of an agricultural harvester 100 that operates autonomously or by remote control. Operation of the ECU 302 to implement the crop residue monitoring system 300 is discussed in greater detail with FIG. 4.

Reference is now made to FIG. 4, which illustrates exemplary components of an ECU 302 that may be used to monitor crops residue and control the spreading of crop residue. As introduced above and depicted in FIG. 4, aspects of the crop residue monitoring system 300 may be organized within the ECU 302 as one or more functional systems, units, or modules 400, 402, 404, 406, 408 (e.g., software, hardware, or combinations thereof), including some or all of sensor priorities 400, an image quality module 402, a residue detection module 404, a selection module 406, and a control algorithm 408. As can be appreciated, the functional systems, units, or modules 400, 402, 404, 406, 408 shown in FIG. 4 may be combined and/or further partitioned to carry out similar functions to those described herein. Moreover, one or more of the modules 400, 402, 404, 406, 408 may be omitted.

The ECU 302 may be configured with sensor priorities 400. For example, among the available cameras 142, 144, 146, 150, 152, 154, the capacity of a given camera to detect the plume of residue 130 may vary relative to other cameras due to viewing angle, degree of overlap between the field of view of the camera and the possible coverage area of the plume of residue 130, likelihood of being obscured by dust or other obscurants, or other factors. Accordingly, each sensor may be assigned a priority corresponding to the ability of the sensor to image the plume of residue 130 relative to other sensors. For example, camera 154 may have a higher rank than a camera 156 due to the camera 154 having a more complete field of view of the plume of residue 130. The sensor priorities 400 may be assigned by a human user or selected automatically. The sensor priorities 400 may be in the form of an ordered list of identifiers of the cameras 142, 144, 146, 150, 152, 154, 156 or a mapping associating an identifier of a given camera of the cameras 142, 144, 146, 150, 152, 154, 156 with the priority of that camera.

The ECU 302 may be configured with an image quality module 402. The image quality module 402 evaluates the output of each sensor to identify one or more features that indicate the suitability of the output for characterizing the plume of residue 130 (e.g., the “features of quality”). For example, each image received from the cameras 142, 144, 146, 150, 152, 154, 156 may be evaluated by the image quality module 402 to identify a fraction (e.g., percentage) of pixels of the image that correspond to dust or other obscurants. Each image may be evaluated by the image quality module 402 to determine the lighting of the image, e.g., a degree to which the field of view of the camera that captured the image is illuminated. For example, the image quality module 402 may evaluate whether the image is illuminated above a threshold level of illumination.

The functions of the image quality module 402 may be implemented using an algorithm characterizing pixels of each image. For example, a pattern matching algorithm may be used to identify pixels or regions of an image corresponding to dust. Likewise, the lighting of the image may be determined by executing an algorithm with respect to pixels of the image.

In some embodiments, some or all of the functions of the image quality module 402 may be implemented using a machine learning model. For example, a machine learning model may be trained to identify portions of an image corresponding to dust. The machine learning model may be trained with a plurality of training data entries, each training data entry including an image as an input and a fraction of the image including dust or other obscurants as a desired output as determined by a human labeler. The machine learning model may process the training data entries in cooperation with a machine learning algorithm to train the machine learning model to output a fraction of an image obscured by dust or other obscurants for a given input image.

The image quality module 402 may additionally or alternatively determine other features of quality such as sharpness, contrast, image noise, or other properties. These features of quality may likewise be determined using an algorithm or machine learning model trained to perform this task.

The ECU 302 may be configured with a residue detection module 404. The residue detection module 404 determines, for a given image, one or more features of merit of the plume of residue 130 represented in the image. For example, the features of merit may include some or all of a location, a spread edge, a width of the plume of residue 130, a distribution of the plume of residue, and direction in which the plume is falling on the ground behind the agricultural harvester 100, e.g., how far to the right and/or how far to the left of the agricultural harvester 100. The one or more features of merit may additional or alternatively include characteristics of the crop residue itself such as a numerical statistic such as average residue/straw length. The characteristics may include a categorization of the crop residue such as a type of crop residue, percent of different types of crop residue found in the image of the like. The characteristics may include a categorization of the crop residue in terms of processing of the crop residue such as under processed, over processed and the like, wherein the “processing” refers to the degree to which the crop residue has been changed or reduced in size by the harvester.

The residue detection module 404 may be implemented as one or more machine vision algorithms configured to identify one or more of the features of merit in a given image. The residue detection module 404 may alternatively or additionally include one or more machine learning models trained to identify one or more of the features of merit in a given image.

As noted, the cameras 142, 144, 146, 150, 152, 154, 156 may have different characteristics, viewing angles, and fields of view. Accordingly, different machine vision algorithms and/or different machine learning models may be provided for different cameras 142, 144, 146, 150, 152, 154, 156 by the residue detection module 404.

In one example configuration, the residue detection module 404 includes a pipeline of multiple stages to calculate one or more of the features of merit. For example, a first stage may include a machine vision algorithm or machine learning algorithm that identifies portions of an image corresponding to crop residue. One or more subsequent stages may then evaluate the portions of the image to obtain a numerical characterization of the portions, such as one or more of the above-listed features of merit.

Where the residue detection module 404 includes one or more machine learning models, the one or more machine learning models may be trained using a plurality of training data entries, each training data entry including an image as an input and a label indicating portions of the image corresponding to the plume of residue 130 or a feature of merit as the desired output. The machine learning model may process the training data entries in cooperation with a machine learning algorithm in order to train the machine learning model to output labels for the portion of the image corresponding to the plume of residue 130 and/or one or more features of merit.

The residue detection module 404 may further output one or more confidence scores, such as a confidence score associated with each feature of merit determined by the residue detection module 404 by analyzing a given image. The one or more confidence scores for one or more features of merit indicate a degree of certainty associated with the one or more features of merit. For example, each confidence score may be a value from 0 to 1, with 1 indicating a high degree of certainty. The confidence score may be an inherent output of the machine learning model used to obtain one or more features of merit or may be obtained using a separate algorithm. Likewise, a machine vision algorithm may output a confidence score for one or more features of merit output by the machine vision algorithm or a separate algorithm may calculate the confidence score for the machine vision algorithm. In some embodiments, the confidence score may additionally or alternatively be a function of the features of quality.

The ECU 302 may be configured with a selection module 406. The selection module 406 is configured to select an image to be used to characterize the plume of residue 130 in order to control the operation of the actuators 304 (hereinafter “the selected image”). The selected image is selected from two or more images received from two or more cameras of the cameras 142, 144, 146, 150, 152, 154, 156, such as two or more most recent images received from the two or more cameras as of a time that the selection module begins performing a selection algorithm. The two or more images may be one or both of (a) two or more images received from two or more 3 cameras 142, 144, 146, 150, 152, 154, 156 at the about the same time (e.g., between 0.01 and 1 seconds) and (b) two or more images received from a same camera 142, 144, 146, 150, 152, 154, 156 at different times. The selection module 406 may receive as inputs for each image, some or all of a priority of the camera that captured the image, the features of quality for the image, the features of merit for the image, and the one or more confidence scores for the image. The selection module 406 may then perform the selection algorithm with respect to these inputs and select the selected image from the two or more images.

The selection algorithm may be a series selection algorithm, a parallel algorithm, or some other selection algorithm. In the series algorithm, the two or more images are processed in order from highest to lowest priority. An image is processed by evaluating the features of quality and the one or more confidence scores. If the features of quality and the one or more confidence scores meet a threshold condition, the image is used as the selected image. If the features of quality and the one or more confidence scores do not meet a threshold condition, the series algorithm processes the next image in a like manner, i.e., the next image in the series of images ordered by priority. The threshold condition may be a single threshold with respect to which a combination of the features of quality and the one or more confidence scores are evaluated (e.g., a sum, weighted sum, product, or other combination). Evaluating the threshold condition may include evaluating the features of quality with respect to one or more quality thresholds and evaluating the one or more confidence scores with respect to one or more confidence thresholds such that the threshold condition is met only if the features of quality meet all of the one or more quality thresholds and the one or more confidence scores meet all of the one or more confidence thresholds.

In a parallel algorithm, each image of the two or more images is assigned an overall score as a function of the priority, features of quality, and confidence score of the image. The image with the highest overall score is then selected as the selected image. For example, the overall score may increase with increasing priority, decrease with increasing values for the features of quality (assuming higher values indicate more dust, poor lighting, or other undesirable quality), and increase with increasing confidence score. The overall score may be obtained by summing, weighting and summing, or otherwise combining the priority, features of quality, and confidence score. One or more of the constituent parts of the overall score, e.g., features of quality, may be inverted or negated prior to combining.

The selection module 406 may provide one or more outputs to a control algorithm 408 for the selected image such as the features of merit for the selected image and possibly the selected image itself. The one or more outputs may additionally include one or both of the priority and features of quality for the selected image.

The control algorithm 408 may control operation of one or more of the actuators 304 based on the features of merit. For example, the spreader mechanism 126 may be accelerated if the width of the plume of residue 130 is too narrow or decelerated if the width is too large. One or more vanes of the spreader mechanism 126 may be adjusted to move the plume of residue 130 to the right (or the left) where the features of merit indicate that the plume of residue is off center to the left (or to the right). In a like manner, the height of the agricultural harvesting head 104 and/or speed of the chopper 124 may be increased or decreased based on the features of merit. The relative orientation of knives of the chopper may be adjusted based on the features of merit. The drive train 306 may be directed to slow down or speed up based on the features of merit. Moreover, the display device 308 may be modified by the ECU 302 to reflect some aspect of the crop residue monitoring functions (e.g., functioning as an actuator as part of the crop residue monitoring system 300).

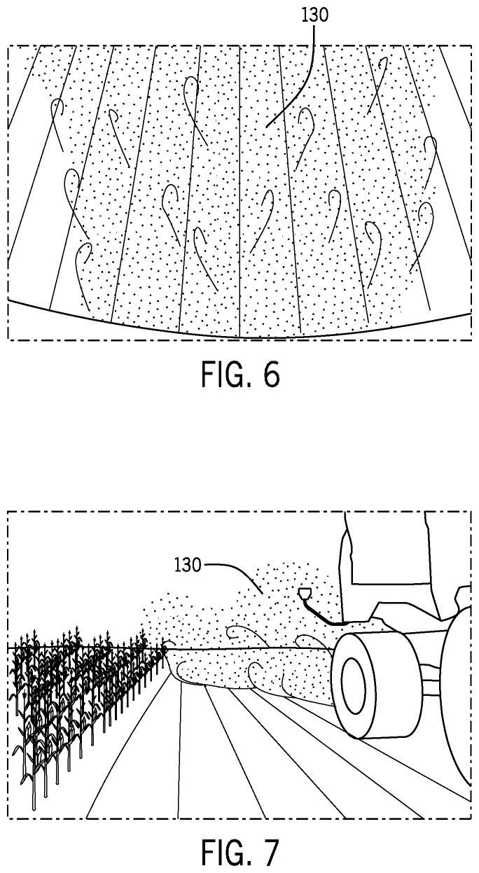

FIG. 5 illustrates a method 500 that may be executed by the ECU 302 or other computing device hosted by the agricultural harvester 100 or remote from the agricultural harvester 100. The method 500 may include some or all of the illustrated steps and the illustrated steps need not be performed in the order shown in FIG. 5. The method 500 may include capturing, at step 502, two or more images from a single camera or two or more cameras, such as two or more of the cameras 142, 144, 146, 150, 152, 154, 156. Reference is again made to FIGS. 6-8, which respectively depict images from camera 154, camera 150, and camera 156. As is readily apparent, the image of FIG. 6 from camera 154 has more of the plume of residue 130 in the field of view thereof. Accordingly, the camera 154 may have a higher priority than the cameras 150, 156. Camera 150 may have a higher priority than the camera 156 as having more of the plume of residue 130 in the field of view thereof as shown in FIGS. 7 and 8.

The two or more images may be processed at step 504 to determine the features of quality for each image of the two or more images. Step 504 may include processing each image of the two or more images using the image quality module 402 to determine the features of quality as described above. In particular, step 504 may include detecting, at step 506, an image light level (e.g., whether the light level meets a lighting threshold) and detecting, at step 508, dust in the image. Step 504 may additionally or alternative include identifying, at step 508, one or more other image attributes, such as sharpness, contrast, image noise, or the like.

The two or more images may be processed at step 510 to determine the features of merit of the two or more images. The processing at step 510 may include processing the two or more images with the residue detection module 404 to obtain the features of merit as described above. As noted above, the residue detection module 404 may further output, at step 510, one or more confidence scores for each image of the two or more images.

At step 512, some or all of (a) the priorities, (b) the features of quality, and (c) the one or more confidence scores of the two or more images may be evaluated in order to select an image of the two or more images as the selected image. Step 512 may include performing the functions of the selection module 406 as described above.

At step 514, the features of merit are processed by a control algorithm. The control algorithm processed the features of merit to determine how to control one or more actuators of the actuators 304. Step 514 may include processing the features of merit using the control algorithm 408 as described above. The one or more actuators may then be controlled at step 516 according to one or more outputs of the control algorithm as described above with respect to the control algorithm 408.

In addition to or as part of step 514, in some embodiments, the method 500 may include displaying, at step 518, feedback, such as on the display device 308. The feedback may include one or both of the features of quality or the features of merit for the selected image or for multiple images of the two or more images. The feedback may include the one or more confidence scores for the selected image or multiple images of the two or more images. The feedback may further include the selected image or multiple images of the two or more images. For example, the selected image may be displayed with annotations showing the portions of the selected image representing the plume of residue 130, dust represented in the selected image, or other features present in the selected image.

In some embodiments, where the features of quality of the selected image meet a quality threshold, the selected image is displayed and the display of other information is suppressed, such as by suppressing display of one or more of the features of quality, features of merit, and confidence scores for the selected image. In such embodiments, where the features of quality of the selected image do not meet the quality threshold, the selected image is not displayed and display of the other information described above is not suppressed.

As will be appreciated by one skilled in the art, certain aspects of the disclosed subject matter may be embodied as a method, system (e.g., a work vehicle control or power system included in a work vehicle), or computer program product. Accordingly, certain embodiments may be implemented entirely as hardware, entirely as software (including firmware, resident software, micro-code, etc.) or as a combination of software and hardware (and other) aspects. Furthermore, certain embodiments may take the form of a computer program product on a computer-usable storage medium having computer-usable program code embodied in the medium.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be non-transitory and may be any computer readable medium that is not a computer readable storage medium and that may communicate, propagate, or transport a program for use by or in connection with an instruction execution system, apparatus, or device.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the work vehicles and the control systems and methods described herein are merely exemplary embodiments of the present disclosure.

For the sake of brevity, conventional techniques related to work vehicle and engine operation, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

The description of the present disclosure has been presented for purposes of illustration and description, but it is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A monitoring system for an agricultural machine, comprising:
one or more sensors mounted to one or more locations on the agricultural machine; and
a controller configured to:
receive a plurality of sensor outputs from the one or more sensors;
determine one or more features of quality for one or more sensor outputs of the plurality of sensor outputs;
determine one or more features of merit for the one or more sensor outputs of the plurality of sensor outputs, the one or more features of merit corresponding to operation of the agricultural machine and having one or more confidence scores associated therewith;
select a sensor output from the plurality of sensor outputs as a selected sensor output according to the one or more features of quality for the one or more sensor outputs of the plurality of sensor outputs; and
control the operation of the agricultural machine according to the one or more features of merit for the selected sensor output.

2. The monitoring system of claim 1, wherein the one or more features of quality for the one or more sensor outputs of the plurality of sensor outputs includes a fraction of the one or more sensor outputs of the plurality of sensor outputs obscured by an obscurant.

3. The monitoring system of claim 1, wherein the one or more features of quality for the one or more sensor outputs of the plurality of sensor outputs includes a characterization of lighting represented in the one or more sensor outputs of the plurality of sensor outputs.

4. The monitoring system of claim 1,
wherein the one or more features of merit characterize a plume of crop residue released by the agricultural machine and represented in one or more sensor outputs of the plurality of sensor outputs; and
wherein the one or more features of merit include at least one of a width, a distribution, or a direction of the plume of crop residue.

5. The monitoring system of claim 1, wherein the controller is configured to control the operation of the agricultural machine according to the one or more features of merit by controlling at least one of a speed, a position or a direction of at least one of a spreader mechanism, a chopper, or a harvester head.

6. The monitoring system of claim 1, wherein the controller is configured to control operation of the agricultural machine according to the one or more features of merit by controlling a display device.

7. The monitoring system of claim 1, wherein the one or more features of merit correspond to operation of the agricultural machine and have one or more confidence scores associated therewith, and wherein the controller is further configured to select the sensor output as the selected sensor output additionally based on the one or more confidence scores for the one or more sensor outputs of the plurality of sensor outputs.

8. The monitoring system of claim 7, wherein the one or more sensors include a plurality of sensors each having a priority associated therewith; and
wherein the controller is configured to select the sensor output from the plurality of sensor outputs as the selected sensor output according to two or more of the priorities of the plurality of sensors, the one or more features of quality, and the one or more confidence scores for the one or more sensor outputs of the plurality of sensor outputs.

9. The monitoring system of claim 1, wherein the one or more sensors comprise at least one of a light detection and ranging (LIDAR) sensor, a radio detection and ranging (RADAR) sensor, an ultrasonic sensor, an ultraviolet sensor, an infrared sensor, or a visible light camera.

10. The monitoring system of claim 1, wherein the one or more sensors includes two or more cameras, including at least one camera configured to detect rearward of the agricultural machine.

11. A method for monitoring an agricultural machine, comprising:
receiving, by a computing device, a plurality of sensor outputs from one or more sensors mounted to one or more locations on the agricultural machine;
determining, by the computing device, one or more features of quality for one or more sensor outputs of the plurality of sensor outputs;
determining, by the computing device, one or more features of merit for the one or more sensor outputs of the plurality of sensor outputs, the one or more features of merit corresponding to operation of the agricultural machine;
selecting, by the computing device, a sensor output from the plurality of sensor outputs as a selected sensor output according to the one or more features of quality of the one or more sensor outputs of the plurality of sensor outputs; and
controlling, by the computing device, the operation of the agricultural machine according to the one or more features of merit for the selected sensor output.

12. The method of claim 11, wherein the one or more features of quality for the one or more sensor outputs of the plurality of sensor outputs includes a fraction of the one or more sensor outputs obscured by an obscurant.

13. The method of claim 11, wherein the one or more features of quality for the one or more sensor outputs of the plurality of sensor outputs includes a characterization of lighting represented in the one or more sensor outputs.

14. The method of claim 11,
wherein the one or more features of merit characterize a plume of crop residue released by the agricultural machine and represented in the one or more sensor outputs of the plurality of sensor outputs; and
wherein the one or more features of merit include at least one of a width, a distribution, and a direction of the plume of crop residue.

15. The method of claim 11, further comprising controlling, by the computing device, the operation of the agricultural machine according to the one or more features of merit by controlling at least one of a speed, a position, or a direction of at least one of a spreader mechanism, a chopper, or a harvester head.

16. The method of claim 11, further comprising controlling, by the computing device, the operation of the agricultural machine according to the one or more features of merit by controlling a display device.

17. The method of claim 11, wherein the one or more features of merit correspond to operation of the agricultural machine and have one or more confidence scores associated therewith, and wherein the method further comprises:
selecting, by the computing device, the sensor output from the plurality of sensor outputs as the selected sensor output additionally according to the one or more confidence scores for the one or more sensor outputs of the plurality of sensor outputs.

18. The method of claim 17, wherein the one or more sensors include a plurality of sensors each having a priority associated therewith; and
wherein the method further comprises selecting the sensor output from the plurality of sensor outputs as the selected sensor output according to two or more of the priorities of the plurality of sensors, the one or more features of quality, and the one or more confidence scores for the one or more sensor outputs of the plurality of sensor outputs.

19. The method of claim 11, wherein the one or more sensors comprise at least one of a light detection and ranging (LIDAR) sensor, a radio detection and ranging (RADAR) sensor, an ultrasonic sensor, an ultraviolet sensor, an infrared sensor, and a visible light camera.

20. The method of claim 11, wherein the one or more sensors include two or more cameras, including at least one camera configured to detect rearward of a spreader mechanism of the agricultural machine.
